(19) United States
(12) Patent Application Publication
(10) Pub. No.: US 2011/0161809 A1
(43) Pub. Date: Jun. 30, 2011

(54) HAND-HELD ELECTRONIC DEVICE

(76) Inventor: Daniel A. Gilmour, West Hartford, CT (US)

(21) Appl. No.: 12/649,914

(22) Filed: Dec. 30, 2009

(51) Int. Cl. G06F 3/041; G06F 1/32; G06F 3/02

(52) U.S. Cl. 715/702; 713/323; 345/168; 715/773; 345/173

(57) ABSTRACT

A hand-held electronic device includes, a first side that has a first display that is touch sensitive, a second side that has a second display and is positionally fixed relative to the first side, and a physical keyboard disposed at the second side.

### BACKGROUND

Hand-held electronic devices, such as, cell phones, digital music players and global positioning sensor receivers, for example, typically permit operators to input data (alpha-numeric data, for example) directly, via integrated keyboards. These keyboards come in primarily two configurations, virtual keyboards and physical keyboards. Both types of keyboards have limitations and drawbacks that detract from the user experience. Virtual keyboards are displayed on a portion of a touch sensitive display and are manipulated by fingers or thumbs. This type of device sacrifices valuable display area in order to locate the virtual keyboard on the touch sensitive display.

Physical keyboards are another alternative used on some devices to overcome such drawbacks. Locating the physical keyboard adjacent to the display however displaces valuable display area. This loss of display area is not recoverable even when data entry is not being performed and the keyboard is not needed. Other devices include a physical keyboard on a surface that articulates relative to the display either by sliding or rotating via a hinge. Although these designs solve some of the aforementioned issues they result in a greater overall thickness of the device, potential mechanical weakening (due to the articulating componentry) and typically employ flat keys. Hand-held devices that overcome these drawbacks would be well received in the industry.

### BRIEF DESCRIPTION

Disclosed herein is a hand-held electronic device. The device includes, a first side that has a first display that is touch sensitive, a second side that has a second display and is positionally fixed relative to the first side, and a physical keyboard disposed at the second side.

Further disclosed herein is a hand-held electronic device. The device includes, a body defining a first surface and a second surface, the first surface and the second surface face in substantially opposite directions, a touch sensitive display disposed at the first surface, and a physical keyboard disposed at the second surface.

### BRIEF DESCRIPTION OF THE DRAWINGS

The following descriptions should not be considered limiting in any way. With reference to the accompanying drawings, like elements are numbered alike:

FIG. 1 depicts a top view of a hand-held electronic device disclosed herein;

FIG. 2 depicts a side view of the hand-held electronic device of FIG. 1; and

FIG. 3 depicts a bottom view of the hand-held electronic device of FIG. 1.

### DETAILED DESCRIPTION

A detailed description of one or more embodiments of the disclosed apparatus and method are presented herein by way of exemplification and not limitation with reference to the Figures.

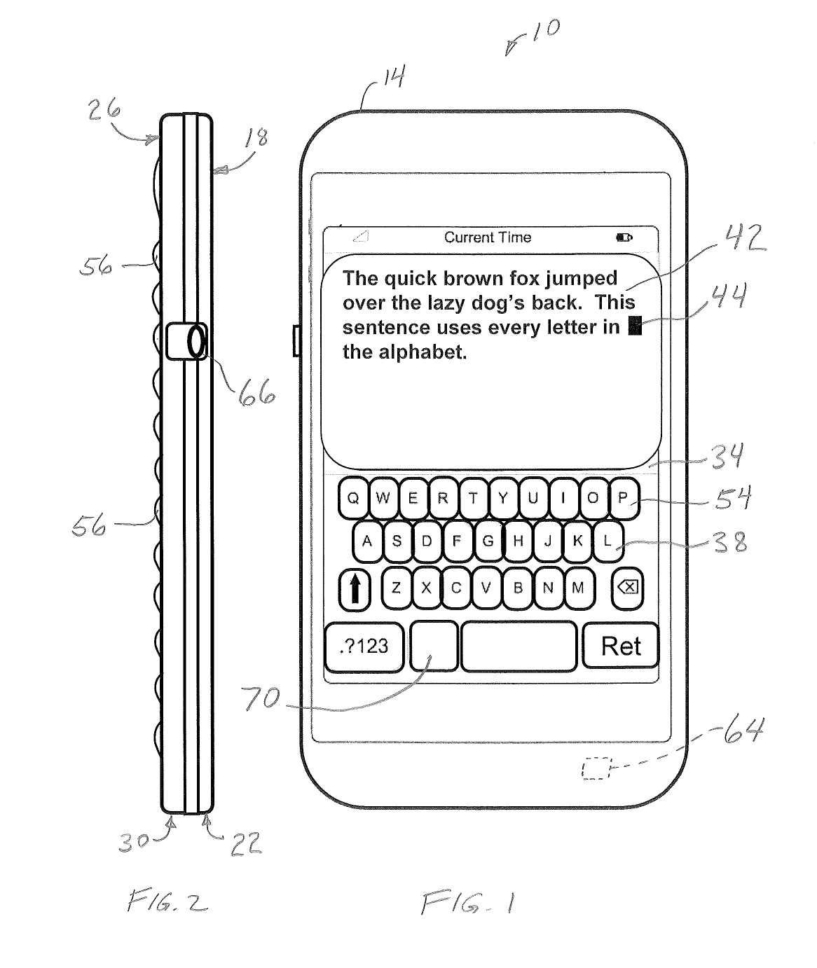

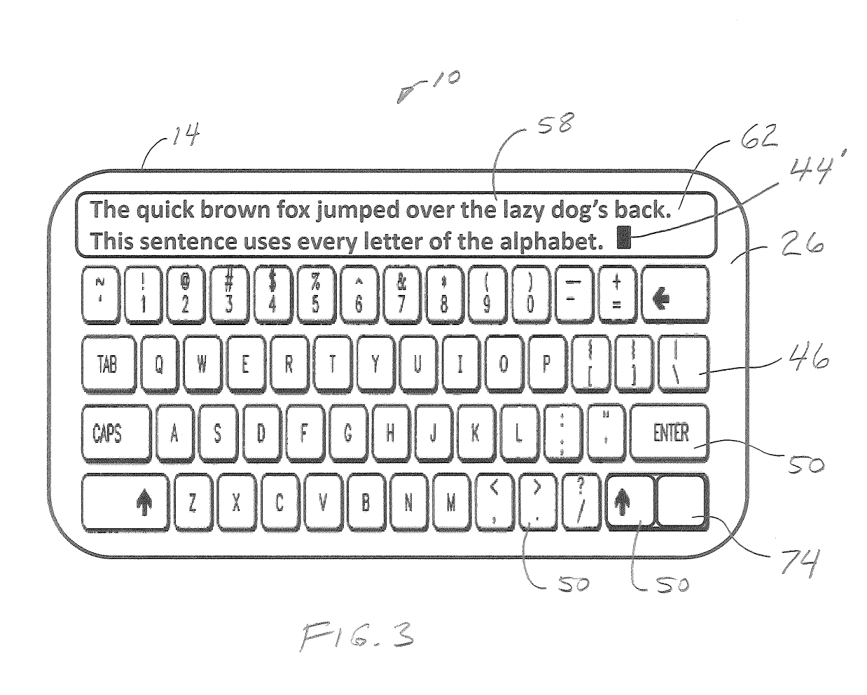

Referring to FIGS. 1-3, an embodiment of a hand-held electronic device disclosed herein is illustrated at 10. The hand-held electronic device includes, a body 14 having a first surface 18 on a first side 22 and a second surface 26 on a second side 30. In this embodiment a first display 34 disposed at the first surface 18 is touch sensitive such that contact of one or more of a user's fingers (not shown) with the first display 34 is detectable. The touch sensitivity of the first display 34 allows an operator to interact with the device 10. This interaction may include, multi-touch gestures, such as, pinching two fingers to shrink the displayed image, spreading two fingers to zoom in on a displayed image, as well as gestures to move the image being displayed and to enter data via a virtual keyboard 38, for example. The data can include alphanumeric character entry, as well as manipulation of a cursor 44, for example, all of which, for purposes of simplification, are described hereunder as data entry. A first data entry area 42 on the first display 34 shows the cursor 44 and the alphanumeric characters as they are entered into the device 10. A physical keyboard 46 disposed at the second surface 26 is also configured to allow data entry in much the same way as the virtual keyboard 38. One primary difference between the two keyboards 38, 46 being individual keys 50 of the physical keyboard 46 are depressed to actuate, while keys 54 of the virtual keyboard 38 are not. Optionally, the keys 50 of the physical keyboard 46 can have raised portions 56 to facilitate a finger distinguishing one of the keys 50 from another. Alternately, the keys 50 can have indentations (not shown), instead of the raised portions 56. Additionally, the keys 50 can individually provide tactile feedback to an operator when the keys 50 are depressed to inform the operator that the selected key 50 has been depressed sufficiently to enter data therefrom.

A second display 58 disposed at the second surface 26 is configured to display a second data entry area 62. The second data entry area 62 displays a cursor 44′ and alphanumeric characters as they are entered, regardless of whether they are entered from the virtual keyboard 38 or from the physical keyboard 46. Similarly, the first data entry area 42 displays the cursor 44 and alphanumeric characters as they are entered, regardless of whether they are entered from the virtual keyboard 38 or the physical keyboard 46. As such, the first data entry area 42 and the second data entry area 62 remain in sync and data entry from either keyboard 38, 46 is duplicated on both of the data entry areas 42 and 62.

It should be noted, however, that even though the two data entry areas 42, 62 are in sync, the displays 34, 58 might display the same alphanumeric characters with different sizes, fonts and colors, for example. Additionally, the two data entry areas 42, 62 can use a different number of character widths as well as a different number of character rows or lines. One of the data entry areas 42, 62, for example, may be presented in portrait mode while the other data entry area 42, 62 may be presented in landscape mode.

In addition to the data entry areas 42, 62 being different, the displays 34, 58 may also be different. The second display 58 may be considerably smaller in area than the first display 34. The first display 34 may take up a significant portion of the first surface 18 while a significant portion of the second surface 26 may be allocated to the physical keyboard 46. The two displays 34, 58 may also employ completely different display technologies. For example, the first display 34 may use a liquid crystal diode (LCD) display, while the second display 58 may use an organic light emitting diode (OLED) display. It may be desirable to use a lower power consuming display technology for the second display 58 as the second display 58 may be dedicated mostly to displaying alphanumeric characters only.

Another method of conserving power while using the hand-held electronic device 10 is to reduce or totally eliminate power to at least one of the displays 34, 58 when not in use. Control of when to reduce or cut power to one of the displays 34, 58 can follow methods of disabling either of the data entry mechanisms, the touch sensitivity of the first display 34 or the physical keyboard 46. Alternately, the reduced power mode could be activated directly in response to disablement of one or both of the keyboards 38, 46. Another benefit of disabling one of the data entry mechanisms when it is not in use is to prevent inadvertent data entry that could result from contacting one of the keys 54 of the touch sensitive first display 34 or depression of one of the keys 50 of the physical keyboard 46.

Methods of deciding which data entry mechanism to disable include, monitoring orientation of the device 10 relative to a direction of the force of gravity and disabling one or both of the data entry mechanisms based on selected angles of the device 10 in relation to a direction of the force due to gravity. This can be accomplished with an accelerometer 64 (shown in phantom in FIG. 1) disposed within the device 10, for example, for monitoring orientation of the device 10 relative to the direction of the force of gravity. The data entry mechanism that is facing more directly toward the direction of gravity, i.e. downward, for example, could be disabled while permitting data entry from the data entry mechanism that is facing more directly away from the force of gravity. The accelerometer 64 could also be used to determine when to reorient images showing on one or both of the displays 34, 58 between portrait and landscape orientations, for example.

Methods of disabling one of the data entry mechanisms that are directly user selectable could also be employed. For example, a switch 66 having two or three positions could be located so that it would be intuitive as to which position disables which data entry mechanism. For example, moving the switch 66 to a position closer to one of the two sides 22, 30 could disable the data entry mechanism on that side. Having a three-position switch 66 in a third position, centered between the sides 22, 30, could disable neither the touch sensitivity of the first display 34 nor the physical keyboard 46. Still other means, such as a virtual key 70 on the virtual keyboard 38 or a physical key 74 on the physical keyboard 46, could also be employed to toggle disablement of the keyboard 38, 46 on which the key 70, 74 is located. Each of these user selectable methods could be used separately or together.

Regardless of what method of disablement of the data entry mechanisms is employed, the device 10 could be configured to have the virtual keyboard 38 disappear whenever the virtual keyboard 38 is disabled. In so doing, the device 10 no longer must dedicate a portion of the first display 34 to displaying the virtual keyboard 38, as occurs whenever the virtual keyboard 38 is showing. Additionally, automatic reorienting of the image displayed on the first display 34 can be disabled whenever the physical keyboard 46 is enabled. Doing so will enable an operator to quickly and repeatedly reorient the device 10, perhaps to quickly view the first display 34 while entering data on the physical keyboard 46, without having to wait for the display to repeatedly reorient between landscape and portrait in the process.

The keyboards 38, 46, in the embodiment illustrated herein, both employ a full alphabetic layout since each includes a separate key 50, 54 for each letter of the modern English alphabet. Both also employ a standard QWERTY layout, which means the first six keys 50, 54 in the top row of letters starting from left are the letters Q-W-E-R-T-Y. The QWERTY layout is a common keyboard layout for data entry into personal computers and as such is very desirable in hand-held devices since people are familiar with the relative locations of the keys. Alternate keyboard layouts could also be employed such, as the Dvorak layout, also known as the Simplified Keyboard, as well as non-English language alphabetic keyboards and typical standard layouts that have been established therefor.

Employing a full keyboard (whether virtual or physical) that has a separate key 50, 54 for each letter of an alphabet, however, depending upon the number of characters in the alphabet, can consume a significant portion of the first display 34 as mentioned above. Locating the physical keyboard 46 at the second surface 26 on the second side 30, as disclosed herein, provides a relatively large area for the keys 50 while also permitting the second data entry area 62 to have sufficient area for two or more rows, or lines, of alphanumeric characters.

The physical keyboard 46, illustrated herein is oriented on the second side 30 in a landscape orientation. This configuration may be desirable since the keys 50 of the standard QWERTY layout are distributed with more of the keys 50 in a horizontal direction than a vertical direction, and thus have a natural landscape aspect ratio. However, a portrait orientation of the physical keyboard 46 is contemplated, and may even be desirable for other reasons, including for alphabets that have a natural portrait aspect ratio.

The physical keyboard 46 disclosed herein can be employed on the hand-held electronic device 10 regardless whether the device 10 is a mobile telephone, a video playback device, an audio playback device, a personal digital assistant, a global positioning system device, a computer or combinations of the foregoing.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A hand-held electronic device, comprising:
a first side having a first display being touch sensitive;
a second side having a second display and being positionally fixed relative to the first side; and
a physical keyboard disposed at the second side.

2. The hand-held electronic device of claim 1, wherein the physical keyboard includes a separate key for each letter of an alphabet.

3. The hand-held electronic device of claim 2, wherein keys of the physical keyboard are distributed in standard QWERTY orientation.

4. The hand-held electronic device of claim 1, wherein a character entry area of the first display and a character entry area of the second display remain in sync with one another.

5. The hand-held electronic device of claim 1, wherein the second side faces a direction substantially opposite a direction that the first side faces.

6. The hand-held electronic device of claim 1, wherein the second display is configured to show at least two rows of alphanumeric characters.

7. The hand-held electronic device of claim 1, wherein touch sensitivity of the first display is disabled when keys of the physical keyboard are depressed.

8. The hand-held electronic device of claim 1, wherein touch sensitivity of the first display is disabled in response to the hand-held electronic device being oriented at selected angles relative to the force of gravity.

9. The hand-held electronic device of claim 1, wherein operation of the physical keyboard is disabled in response to the hand-held electronic device being oriented at selected angles relative to the force of gravity.

10. The hand-held electronic device of claim 1, wherein disabling of the touch sensitivity of the first display and disabling operation of the physical keyboard are user selectable.

11. The hand-held electronic device of claim 1, wherein a virtual keyboard on the first display disappears when the touch sensitivity of the first display is disabled.

12. The hand-held electronic device of claim 1, wherein at least one of touch sensitivity of the first display and operation of the physical keyboard are disabled at any time.

13. The hand-held electronic device of claim 1, wherein at least one of a key, a button and a switch are configured to toggle between disabling of the touch sensitivity of the first display and disabling operation of the physical keyboard.

14. The hand-held electronic device of claim 1, wherein at least one of the first display and the second display is configured to enter a reduced power consumption mode in response to one of the touch sensitivity of the first display and operation of the physical keyboard being disabled.

15. The hand-held electronic device of claim 1, wherein the hand-held electronic device is at least one of a mobile telephone, a video playback device, an audio playback device, a personal digital assistant, a global positioning system device and a computer.

16. The hand-held electronic device of claim 1, wherein an automatic reorientation feature of the first display between portrait and landscape is disabled in response to enablement of operation of the physical keyboard.

17. The hand-held electronic device of claim 1, wherein the second display consumes less power than the first display.

18. A hand-held electronic device, comprising:
a body defining a first surface and a second surface, the first surface and the second surface facing in substantially opposing directions;
a touch sensitive display disposed at the first surface; and
a physical keyboard disposed at the second surface.

19. The hand-held electronic device of claim 18, wherein the physical keyboard has a separate key for each letter of the English alphabet and is configured to enter a selected letter of the English alphabet into memory of the hand-held electronic device in response to depression of a key associated with the selected letter.

20. The hand-held electronic device of claim 19, further comprising a second display disposed at the second surface and the selected letter is displayed substantially simultaneously on both the touch sensitive display and the second display when the key associated with the selected letter is depressed.
